(19) United States
(12) Patent Application Publication
(10) Pub. No.: US 2024/0272275 A1
(43) Pub. Date: Aug. 15, 2024

(54) TECHNIQUE TO ENABLE HIGHER COMPRESSION RATIOS IN MMWAVE RADAR

(71) Applicant: Texas Instruments Incorporated, Dallas, TX (US)

(72) Inventors: Sandeep Rao, Bangalore (IN); Anil Mani, Plano, TX (US); Karthik Ramasubramanian, Bangalore (IN)

(21) Appl. No.: 18/222,047

(22) Filed: Jul. 14, 2023

(30) Foreign Application Priority Data
Feb. 13, 2023 (IN) 202341009285

(51) Int. Cl. G01S 7/35

(52) U.S. Cl. CPC G01S 7/352

(57) ABSTRACT

A radar system may include a radar sensor circuit, a compression estimation circuit, a compression circuit, and a data storage circuit. The radar sensor circuit may receive a set of sensor data associated with a radar chirp signal. The radar sensor circuit may generate a set of range data associated with the set of sensor data, which may include first range data for a first range bin and second range data for a second range bin. The compression estimation circuit may determine a first compression ratio for the first range data and a second compression ratio for the second range data. The compression circuit may compress the first and second range data based on the first and second compression ratios respectively. The compressed first and second range data may be stored at the data storage circuit.

### CROSS-REFERENCE TO RELATED APPLICATIONS

This application claims benefit of priority of India Provisional Application Serial No. 202341009285 under 35 U.S.C. § 119, entitled “TECHNIQUE TO ENABLE HIGHER COMPRESSION RATIOS IN MMWAVE RADAR”, filed Feb. 13, 2023, which is hereby incorporated in reference herein in its entirety.

### BACKGROUND

The application of radars such as millimeter-wave (mmwave) radars in civil areas has grown significantly in recent years. For example, radars can be utilized in advanced driver assistance system (ADAS) and automotive vehicles in measurement of distance, velocity, acceleration, and angle. In another example, they can be utilized in medical devices for blood pressure monitoring, emotional monitoring, and sleep monitoring. A radar transmits radar signals as chirps in a unit called a frame, and receives reflected radar signals back from environmental objects. The radar generates digitized data from the transmitted and received radar signals and processes the digitized data to determine distance, velocity, acceleration, and angle measurements. Generally, a radar such as a mmwave radar used in civil areas can be implemented as a semiconductor device. The digitized data corresponding to an individual frame is stored at on-chip memory of the radar prior to start of processing. A larger frame size can allow for better measurement resolutions. However, a larger frame size also requires more on-chip memory and can drive up the area and cost of the radar device. In a radar where the raw frame data is transmitted to a central processor for processing, a larger frame size also means higher throughput requirements. Thus, it is desired to have a technique to efficiently compress and store the digitized data on-chip of radars.

### SUMMARY

This disclosure describes features and implementation associated with a technique for compressing and storing radar data on-chip of a radar system, such as a mmwave radar device used in civil areas. In some examples, a radar system may include a radar sensor circuit, a compression estimation circuit, and a compression circuit. The radar sensor circuit may receive a first set of sensor data associated with a first radar chirp signal and generate a first set of range data associated with the first set of sensor data. The first set of range data may include first range data for a first range bin and second range data for a second rage bin. The compression estimation circuit may determine a first compression ratio based on the first range data and a second compression ratio based on the second range data. The compression circuit may then compress the first range data based on the first compression ratio to generate first compressed range data, and the second range data based on the second compression ratio to generate second compressed range data. The first and second compressed range data may be stored at on-chip memory of the radar system.

In some examples, a method for compressing and storing radar data on-chip of a radar system may include receiving a first set of sensor data associated with a first radar chirp signal. The method may further include generating a first set of range data associated with the first set of sensor data, and the first set of range data may comprise first range data for a first range bin and second range data for a second range bin. The method may further include determining (i) a first compression ratio for the first range data based on the first range data and (ii) a second compression ratio for the second range data based on the second range data. The method may further include compressing (i) the first range data based on the first compression ratio and (ii) the second range data based on the second compression ratio. The method may further include storing the compressed first and second range data at on-chip memory of the radar system.

In some examples, a non-transitory computer readable medium may store program instructions executable by a processor of a radar system. When executed by the processor, the program instructions may cause the process to receive, at a radar sensor circuit of the radar system, a first set of sensor data associated with a first radar chirp signal. The program instructions may further cause the processor to generate, at the radar sensor circuit, a first set of range data associated with the first set of sensor data, and the first set of range data may comprise first range data for a first range bin and second range data for a second range bin. The program instructions may further cause the processor to determine, at a compression estimation circuit of the radar system, (i) a first compression ratio for the first range data based on the first range data and (ii) a second compression ratio for the second range data based on the second range data. The program instructions may further cause the processor to compress, at a compression circuit of the radar system, (i) the first range data based on the first compression ratio and (ii) the second range data based on the second compression ratio. The program instructions may further cause the process to store, at on-chip memory of the radar system, the compressed first and second range data.

These and other features and implementations will be better understood from the following detailed description with reference to the accompanying drawings.

### BRIEF DESCRIPTION OF THE DRAWINGS

FIG. 1 is a block diagram of a radar system in accordance with some examples;

FIG. 2 shows diagrams illustrating radar chirp signals and range data in accordance with some examples;

FIGS. 3A and 3B are diagrams illustrating effects of data compression on range data analysis in accordance with some examples;

FIG. 4 is a flowchart illustrating operations to determine respective compression ratios and compress range data of a plurality of range bins in accordance with some embodiments;

FIG. 5 is a flowchart illustrating operations to determine a compression ratio for a range bin in accordance with some examples;

FIG. 6 is a flowchart illustrating operations of an intra-frame-based estimation in accordance with some examples;

FIG. 7 are diagrams illustrating effects of multiple strong objects in a range in accordance with some examples;

FIG. 8 is a flowchart illustrating operations of a modified intra-frame-based estimation in accordance with some examples;

FIG. 9 is a flowchart illustrating operations of an inter-frame-based estimation in accordance with some examples;

FIG. 10 is a block diagram illustrating implementation of compression circuit and on-chip memory of a radar system in accordance with some examples;

FIG. 11 is a block diagram illustrating another implementation of compression circuit and on-chip memory of a radar system in accordance with some examples;

FIG. 12 is a flowchart illustrating some operations of a radar system in accordance with some examples; and

FIG. 13 is a flowchart illustrating some operations of a radar system in accordance with some examples.

The same reference numbers or other reference designators are used in the drawings to designate the same or similar (functionally and/or functionally) features. Specific examples are described below in detail with reference to the accompanying figures. These examples are not intended to be limiting. In the drawings, corresponding numerals and symbols generally refer to corresponding parts unless otherwise indicated. The objects depicted in the drawings are not necessarily drawn to scale.

### DETAILED DESCRIPTION

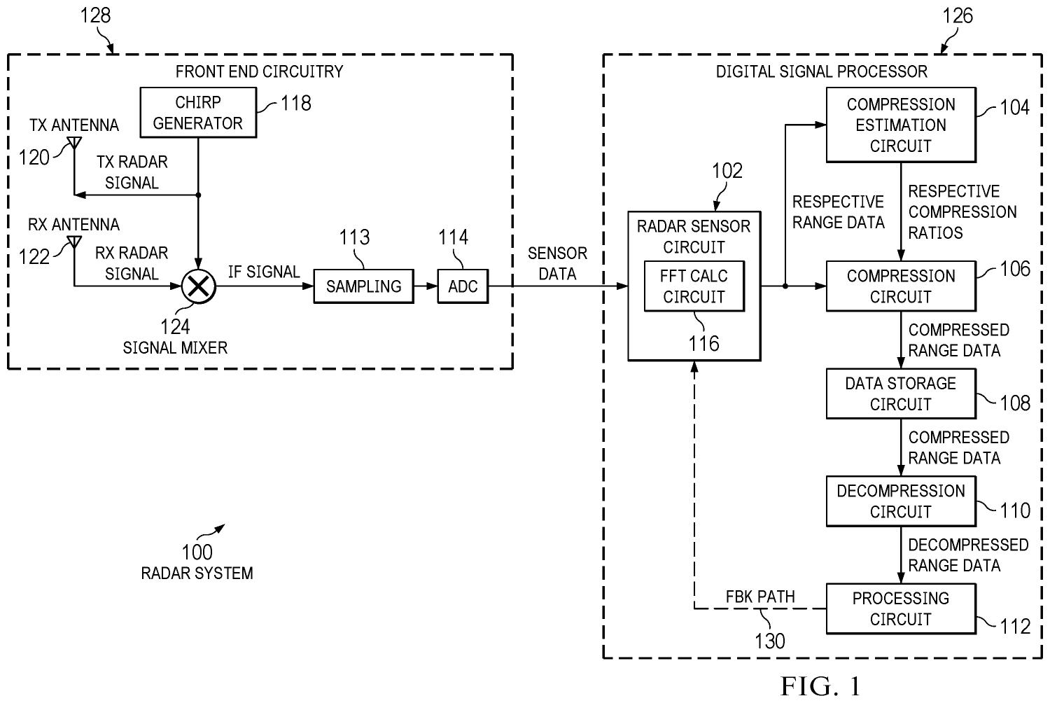

FIG. 1 is a block diagram of a radar system in accordance with some examples. In FIG. 1, a radar system 100 may include a radar sensor circuit 102, a compression estimation circuit 104, a compression circuit 106, a data storage circuit 108, a decompression circuit 110, a processing circuit 112, a sampling circuit 113, a sampling and digital-to-analog converter (ADC) 114, a chirp generator or generation circuit 118, a signal mixer or mixing circuit 124, a transmitting (TX) antenna 120, and a receiving (RX) antenna 122. In some examples, the radar system 100 may be a mmwave radar that may be implemented as a semiconductor device (e.g., a mmwave radar sensor), and the above circuits of the radar system 100 may be implemented as one or more integrated circuits (ICs) or systems on a chip (SOCs) within the semiconductor device. Also note that FIG. 1 is provided only as an example for purposes of illustration. In some examples, the radar system 100 may include more than one chip. For example, in some examples, the radar sensor circuit 102, compression estimation circuit 104, compression circuit 106, data storage circuit 108, decompression circuit 110, and processing circuit 112 may be implemented within a first chip (e.g., a digital signal processor 126), whereas the sampling circuit 113, ADC 114, chirp generator or generation circuit 118, signal mixer or mixing circuit 124, transmitting (TX) antenna 120, and receiving (RX) antenna 122 may be implemented within a second chirp (e.g., a front end circuitry 128).

In some examples, the chirp generator may be coupled to the TX antenna 120. The chirp generator 118 may generate radar signals to be transmitted through the TX antenna 120 to the environment. The radar signals may be in the form of one or more frames, and each frame may include one or more chirps. For example, the chirp generator 118 may generate the radar signals using a frequency-modulated continuous wave (FMCW) technique, where each chirp may be a sinusoidal radio wave having a constant amplitude but a variable frequency, and each frame may include one or more periodically repetitive chirps. For purposes of illustration, in this disclosure each chirp of the radar signals is also referred to as a radar chirp signal, and each frame is also referred to as a radar frame signal. Thus, in summary, the radar system 100 may transmit the radar signals as one or more radar frame signals, and each radar frame signal may include one or more radar chirp signals.

In some examples, the radar signals transmitted from the radar system 100 may be reflected by one or more objects (also called “reflectors”) in the environment back to the radar system 100. The reflected radar signals may be received at the RX antenna 122. The reflected radar signals may be considered to include multiple “frames” and “chirps” as well, each corresponding to a respective one of the frames and chirps of the transmitted radar signals.

In some examples, the signal mixer 124 may be coupled to the chirp generator 118 and/or the TX antenna 120, and the RX antenna 122. The transmitted radar signals and received radar signals may be obtained at the signal mixer 124. The signal mixer 124 may “mix” the signals to generate corresponding intermediate frequency (IF) signals. For example, for a given radar chirp signal and its corresponding reflected radar signal, the signal mixer 124 may perform multiplication of the two signals and filtering of the result to generate a corresponding IF signal. Note that FIG. 1 is only an example provided for purposes of illustration. In some examples, a radar system may have multiple TX and/or multiple RX antennas. For example, when there are multiple RX antennas, each transmitted chirp signal may result in multiple received signals (one at each RX antenna) and hence multiple IF signals.

In some examples, the sampling circuit 113 may be coupled to the signal mixer 124, and the sampling circuit 113 may be further coupled to the ADC 114. The sampling circuit 113 may sample each IF radar signal (e.g., corresponding a respective radar chirp signal), and the ADC circuit 114 may convert the samples to a set of digitized data.

In some examples, the radar sensor circuit 102 may be coupled to ADC 114. The radar sensor circuit 102 may obtain the digitized data. The radar sensor circuit 102 may include a frequency domain analysis circuit 116. The frequency domain analysis circuit 116 may perform frequency domain analysis, such as fast Fourier transformation (FFT), of each set of the digitized data to generate a corresponding set of FFT data.

In some examples, the radar sensor circuit 102 may sort the FFT data into a set of range bins by time of arrival relative to the transmitted radar signals. The time interval may be proportional to the round-trip distance to the object(s) reflecting the radar signals. In the context of radar applications, the distance is also referred to as “range.” Thus, the FFT data within each range bin is also referred to as range data that further corresponds to a respective range.

In some examples, the range data may be compressed by the compression circuit 106 to generate compressed range data, which may be further stored at the data storage circuit 108. Traditionally, a radar compresses the range data associated with different range bins and/or different radar chirp signals based on the same compression ratio. As described in more detail below, compression may compromise the data analysis and/or data compression performance. Thus, to address this problem, the radar system 100 disclosed herein may include a radar estimation circuit 104 to determine a particular compression ratio for range data of each one of the range bins. For example, the set of range data corresponding to a radar chirp signal may include first range data for a first range bin (corresponding to a first range) and second range data for a second range bin (corresponding to a second range). In some examples, the compression estimation circuit 104 may be coupled to the radar sensor circuit 102. The compression estimation circuit 104 may obtain the first and second range data, and determine a first compression ratio for the first range data and a second compression ratio for the second range data. In that regard, the first and second compression ratios may vary due to the use of different compression techniques and/or compression rates. In some examples, the respective compression ratios may apply less (or no) compression to the range bin(s) contain a weaker reflector and more compression to the range bin(s) that contain a stronger reflector.

In some examples, the compression circuit 106 may be coupled to the radar sensor circuit 102 and the compression estimation circuit 104. The range data and their respective compression ratios may be obtained at the compression circuit 106. Accordingly, the compression circuit 106 may compress the range data based on their respective compression ratios. In the above example, the compression circuit 106 may compress the first range data based on the first compression ratio to generate first compressed range data, and the second range data based on the second compression ratio to generate second compressed range data. In some examples, the compression circuit 106 may determine a compression algorithm based on a given compression ratio, and the compression algorithm may be a lossy or lossless compression algorithm. For example, the compression algorithm may include the block floating point (BFP) compression algorithm, Exponential Golomb Encoding (EGE), discrete cosine transform (DCT), transform coding, run-length encoding, Lempel-Ziv-Welch, Huffman coding, etc. For a given compression algorithm, the compression circuit 106 may determine appropriate parameter(s) for the compression algorithm to achieve the specific compression ratio(s).

In some examples, the data storage circuit 108 may be coupled to the compression circuit 106. The compressed range data (e.g., the first and second compressed range data in the above example) may be stored at the data storage circuit 108. As described above, in some examples, the range data corresponding to the same radar frame signal may need to be stored at the data storage circuit 108 before start of processing. Thus, when the range data is compressed, the corresponding compressed range data corresponding to the entire frame may be stored at the data storage circuit 108. In some examples, the data storage circuit 108 may be implemented using any appropriate type(s) of on-chip memory of a semiconductor device, e.g., flash memory, random-access memory (RAM), static RAM (SRAM), and/or electrically erasable programmable ROM (EEPROM).

In some examples, the decompression circuit 110 may be coupled to the data storage circuit 108. The compressed range data may be obtained at the decompression circuit 110 for processing. The decompression circuit 110 may decompress the compressed range data to generate corresponding decompressed range data.

In some examples, the processing circuit 112 may be coupled to the decompression circuit 110. The decompressed range data may be obtained at the processing circuit 112 to determine distance, distance, velocity, acceleration, and/or angle measurements. For example, the processing unit 112 may analyze the range data of one or more range bins corresponding to one radar chirp signal to determine an object's range. Additionally, the processing unit 112 may perform velocity analysis of range data in multiple range bins corresponding to the same range but across different chirps of the same frame to determine an object's velocity. The velocity analysis may also include frequency domain analysis (e.g., FFT calculations). Thus, in some examples, the processing unit 112 may optionally re-use the frequency domain analysis circuit 116 to perform the analysis, as indicated by the feedback path 130.

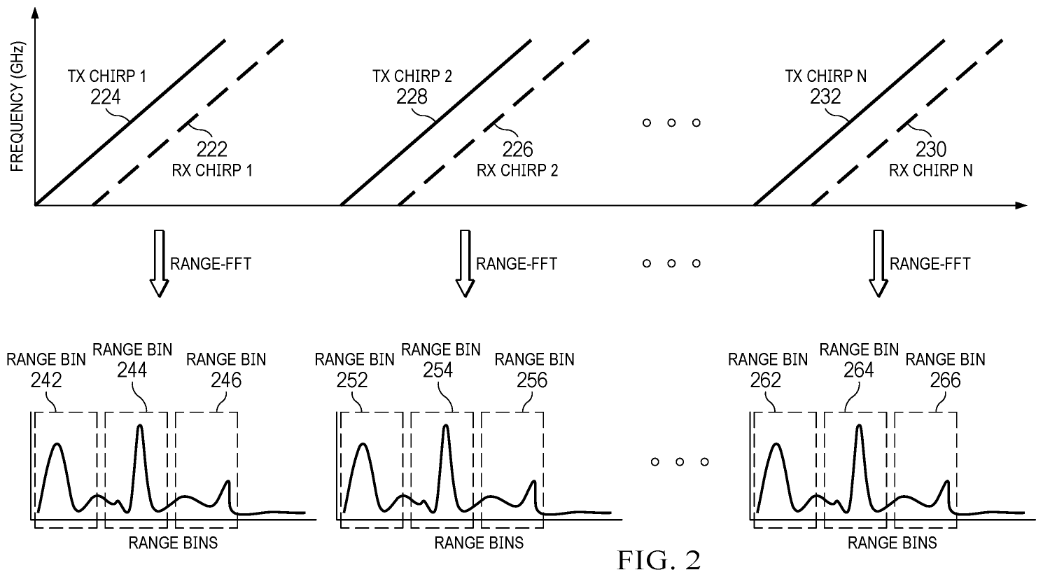

FIG. 2 shows diagrams illustrating radar chirp signals and range data in accordance with some examples. The upper diagram shows transmitted radar chirp signals and their corresponding reflected radar signals. The horizontal axis represents time, and the vertical axis represent frequency. As shown in the diagram, the transmitted radar chirp signals 224, 228, and 232 may each have a variable frequency, e.g., increasing linearly from a lower frequency to an upper frequency. The reflected radar signals 222, 226, and 230 may each correspond to the transmitted radar chirp signals 224, 228, and 232 and thus have a similar quasi-sawtooth waveform in the frequency domain. Note that FIG. 2 is provided only as an example for purposes of illustration. In some examples, the radar chirp signals 224, 228, and 232 (and thus their corresponding reflected radar signals 222, 226, and 230) may be generated using other types of modulation techniques. For example, the radar chirp signals may be generated using FMCW modulation to have a variable frequency in a triangle (not sawtooth) waveform. Additionally, as described above, in some examples, a radar system may include multiple TX antennas and/or multiple RX antennas, and there may be multiple reflected radar signals corresponding to a transmitted radar chirp signal, each corresponding to a different RX antenna.

As described above, in some examples, a radar system (e.g., one similar to the radar systems described above) may obtain both the transmitted and received radar signals to generate intermediate frequency (IF) signals. The radar system may sample the IF signals and perform ADC conversion to generate sensor data. The radar system may perform Fourier analysis of the sensor data to generate range data. In case there are multiple RX antennas present, the range data may be generated for signals from each RX antenna. The range data may be organized into range bins each corresponding to a respective range. In shown, for example, the range data associated with the radar chirp signal 224 may be sorted into range bins 242, 244, and 246, the range data associated with the radar chirp signal 228 may be sorted into range bins 252, 254, and 256, and the range data associated with the radar chirp signal 232 may be sorted into range bins 262, 264, and 266. Thus, the range data within range bins associated with a radar chirp signal may correspond to different ranges. For example, the range data for the range bin 242 may correspond to a first range, the range data for the range bin 244 may correspond to a second range, and the range data for the range bin 246 may correspond to a third range. Additionally, since the range bins are created based on ranges that are determined further according to the time of arrival of reflected radar signals, the range data within the range bins associated with different radar chirp signals may correspond to a same range. For example, the range data for the range bins 242, 252, and 262 may all correspond to the first range, the range data for the range bins 244, 254, and 264 may all correspond to the second range, and the range data for the range bins 246, 256, and 266 may all correspond to the third range. Further, the radar chirp signals 224, 228, and 232 may belong to different radar frame signals. For example, the radar chirp signals 224 and 228 may correspond to a first radar frame signals, and the radar chirp signal 232 may correspond to a second radar frame signal.

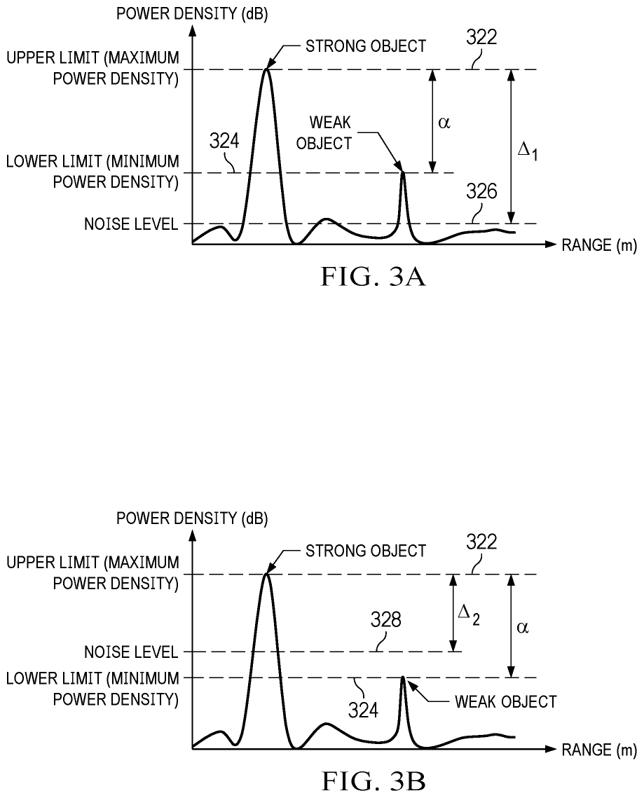

FIGS. 3A and 3B are diagrams illustrating effects of data compression on range data analysis in accordance with some examples. In FIG. 3A, the horizontal axis represents range, and the vertical axis represents power density (also called “power level”) of an object, e.g., in the units of decibel or dB, which may correspond to the likelihood of a reflector object being present at a given range. Thus, as shown, the range data may include one or more peak power levels, each of which may correspond to an object. Analysis of the range data may include detection of these peak values. For purposes of illustration, FIG. 3A shows two peak values—e.g., the upper limit 322 and lower limit 324. Peak value(s) below the lower limit 324 may be categorized as noise and ignored in analysis of the range data. In other words, the upper limit 322 may be the maximum detected power level for the range bin, whereas the lower limit 324 may be the minimum detected power level that is deemed to be associated with an object for the range bin. Considering that, in the example, the peak values correspond to objects instead of noise, the upper limit 322 may correspond to the strongest object that is deemed to be detected within the range bin, and the lower limit 324 may correspond to the weakest object that is deemed to be detected within the range bin.

Data compression may reduce sensitivity, causing the system to be less sensitive to noise but also less sensitive to weak reflectors. The power density range, below which signals are ascribed to noise and ignored may be represented by the noise level 326 in FIG. 3A. Thus, to ensure detection of all the objects that are deemed to be detected for the range bin, when compressed, the range data (compressed or otherwise) may need to provide a sufficient signal to noise ratio (SNR). For example, the noise level 326 may be set lower than the lower limit 324 for the weakest reflector of interest to be detected. Or in other words, the upper limit 322, the lower limit 324, and the noise level 326 may be selected to satisfy equations (1)-(3):

$$α = upper limit 322 - lower limit 324 \qquad ( 1 )$$

$${Δ}_{1} = upper limit 322 - noise level 326 \qquad ( 2 )$$

$$α < {Δ}_{1} \qquad ( 3 )$$

Variation of the compression ratio of the range data may cause change to the noise level 326. In some examples, an increase of the compression ratio may cause an increase in the noise level 326 (e.g., reduce sensitivity), whereas a reduction of the compression ratio may lower the noise level 326 (e.g., increase sensitivity). FIG. 3B shows the effects of the increase of the compression ratio, where the noise level may increase to the noise level 328 in FIG. 3B (compared to the noise level 326 in FIG. 3A). Accordingly, the difference between the upper limit 322 and the noise level 328 may change to Δ2 according to equation (4):

$${Δ}_{2} = upper limit 322 - noise level 328 \qquad ( 4 )$$

As a result, as shown in FIG. 3B and equation (5) below, the difference between the upper limit 322 and the lower limit 324 (or α) may not necessarily be less than the difference between the upper limit 322 and the noise level 328 (or Δ₂) anymore.

$$α > {Δ}_{2} \qquad ( 5 )$$

Or in other words, the noise level 328 may become larger than the lower limit 324 (corresponding to the weakest object to be detected for the range bin). As a result, the weakest object may be “buried” (or masked) by the noise level and may not necessarily be able to be detected anymore. Thus, to ensure sufficient object detection precision, the compression ratio may need to be selected to not mask the weakest object deemed to be detected for the range bin.

As described above, traditional radar systems may use the same compression ratio to compress the range data associated with different range bins and/or different radar chirp signals. However, as described, different range bins may have different upper limits and lower limits of power densities caused by reflectors therein. As a result, some traditional radars may use a worst-case scenario across the different range bins to determine a compression ratio. Since the compression ratio is based on the worst case for all the range bins, it may not necessarily consider the different upper and/or lower limits of range data of individual range bins and thus may be too conservative and not compression efficient. Thus, as described above, to address the problem, the radar systems disclosed herein may include a compression estimation circuit to analyze the individual range bins and determine a particular compression ratio for each of the range bins.

In some examples, to perform the compression ratio determination for a k^{th} range bin, a compression estimation circuit of a radar system (e.g., one similar to the compression estimation circuits described above) may obtain the radar cross section (RCS) of a specified object for the k^{th} range bin. In some examples, the specified object may be the weakest object that is deemed to be detected by the radar system. In this case, the RCS may be a constant value for different range bins. Further, the RCS may be decided during the design phase and included in the specification of a radar system. Alternatively, in some examples, the compression estimation circuit may specify different RCSs for different range bins. For purposes of illustration, the RCS is denoted as σ_{weak}. Given σ_{weak}, the compression estimation circuit 104 may determine a power density P_{weak} (corresponding to σ_{weak}) for the k^{th} range bin based on the radar equation (6). Referring back to FIGS. 3A and 3B, P_{weak} may correspond to the lower limit 324.

$${P}_{weak} = \frac{{P}_{t} {G}_{t}}{4 π {R}^{2}} \times \frac{{σ}_{weak} {A}_{e}}{4 π {R}^{2}} \qquad ( 6 )$$

where Pₜ represents the peak power density of the corresponding (transmitted) radar chirp signal, Gₜ represents the transmit gain, Aₑ represents the effective area of the RX antenna, and R represents the corresponding range of the k^{th} range bin.

In some examples, the compression estimation circuit may further determine a maximum value Pₖ of the range data of the k^{th} range bin. Referring to FIGS. 3A and 3B, Pₖ may correspond to the upper limit 322. In some examples, Pₖ may be identified by searching for the maximum power level of the range data within the k^{th} range bin. Note that in the case of multiple RX antennas, the maximum power level of the range data may be the maximum (within the k^{th} range bin) across the range data corresponding to all the RX antennas. According to equations (1)-(3) described above, the compression estimation circuit may determine Δₖ and the noise level for the k^{th} range bin according to equations (7)-(8):

$${Δ}_{k} = {P}_{k} - {P}_{we ak} + {P}_{det} \qquad ( 7 )$$

$${P}_{noise} = {P}_{k} - {Δ}_{k} \qquad ( 8 )$$

where Pₙₒᵢₛₑ represents the noise level (e.g., the noise level 326 in FIG. 3A), and P_{det} represents an optional design margin. Note that in the above equations the noise and target levels are assumed to be in dB scale. According to equations (7)-(8), the above calculations may ensure that P_{weak} (the lower limit of power densities of the objects to be detected for the k^{th} range bin) is larger than Pₙₒᵢₛₑ (the noise level of the k^{th} range bin). Given Δₖ and/or Pₙₒᵢₛₑ, in some examples, the compression estimation circuit may determine a particular compression ratio for the k^{th} range bin based on Δₖ and/or Pₙₒᵢₛₑ.

In some examples, a compression ratio may be determined based on Δₖ for a compression algorithm (e.g., BFP, EGE, etc.). Depending on the compression algorithm employed and the number of chirps in a frame, each compression ratio may result in a specific dynamic range. The dynamic range may represent a difference in power levels between the strongest peak and the noise level. For example, if a compression algorithm compresses a range value to Nb bits and there are Nc chirps, the dynamic range may be determined as 6×Nb+10 log₁₀ (Nc). An exemplary table is shown below which assumes a BFP compression algorithm with 128 chirps per frame. In some examples, given Δₖ (e.g., determined according to equation (7) as described above), a compression ratio may be selected as the ratio corresponding to the first entry in the table which has a dynamic range larger than Δₖ. Additionally, in some examples, in the BFP compression, a compression ratio may be modified by choosing an appropriate mantissa bit-width to store each compressed sample. Different compression algorithms may have different parameters that may be selected or configured to achieve a specific compression ratio.

| Compression Ratio | Achievable Dynamic Range |
|---|---|
| 25% | 39 dB |
| 37.5% | 51 dB |
| 50% | 63 dB |

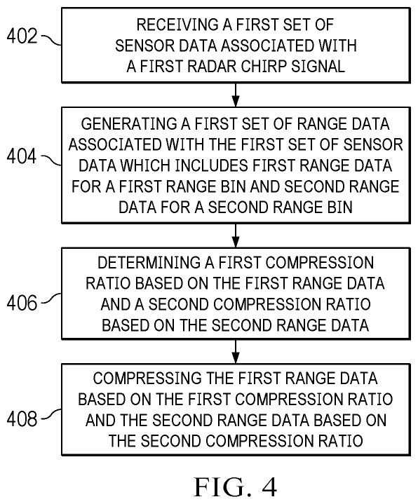

FIG. 4 is a flowchart illustrating operations to determine respective compression ratios and compress range data of a plurality of range bins in accordance with some embodiments. In FIG. 4, a radar sensor circuit of a radar system (e.g., one similar to the radar sensor circuits described above) may receive a first set of sensor data associated with a first radar chirp signal, as indicated by block 402. As described above, in some examples, the first set of sensor data may correspond to the set of digitized data obtained from the IF signal associated with a radar chirp signal (e.g., the radar chirp signal 224).

In some examples, the radar sensor circuit may generate a first set of range data associated with the first set of sensor data, which may include first range data for a first range bin and second range data for a second range bin, as indicated by block 404. In the case of multiple RX antennas, the first set of sensor data may include data for each of the RX antennas, and correspondingly the first set of range data may include range data for all these RX antennas. As described above, a radar sensor circuit may generate a set of range data by performing a range FFT on the digitized data of an IF signal, and the results may be sorted into a set of range bins. For example, as described in FIG. 2, the range data associated with the radar chirp signal 224 may be organized into first range data for range bin 242, second range data for range bin 244, and third range data for range bin 246. The range data of the different range bins may correspond to respective ranges.

In some examples, a compression estimation circuit of the radar system (e.g., one similar to the compression estimation circuits described above) may determine a first compression ratio for the first range data based on the first range data, and a second compression ratio for the second range data based on the second range data, as indicated by block 406.

In some examples, a compression circuit (e.g., one similar to the compression circuits described above) may compress the range data based on their respective compression ratios, as indicated by block 408. For example, the compression circuit may compress the first range data based on the first compression ratio to generate first compressed range data, and the second range data based on the second compression ratio to generate second compressed range data.

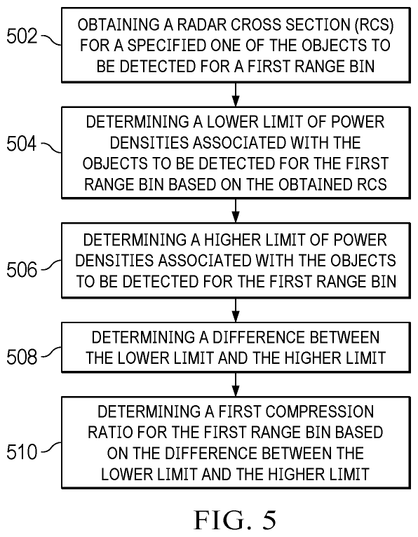

FIG. 5 is a flowchart illustrating operations to determine a compression ratio for a range bin in accordance with some examples. In FIG. 5, in some examples, a compression estimation circuit of a radar system (e.g., one similar to the compression estimation circuits described above) may obtain the RCS (e.g., σ_{weak}) of a specified object for a first range bin, as indicated by block 502. As described above, in some examples, the specified object may be the weakest object that is deemed to be detected by the radar system. In this case, the RCS may be a constant for different range bins (e.g., part of the design specification of the radar system). Alternatively, in some examples, the weakest object deemed to be detected for different range bins may be different, and thus the radar system may use separate RCSs for respective range bins.

In some examples, the compression estimation circuit may determine a lower limit of power densities (e.g., P_{weak}) based on the RCS (e.g., σ_{weak}) for the first range bin, e.g., according to equation (6), as indicated by block 504. As described above, the lower limit may represent the minimum value of power densities of objects to be detected for the first range bin.

In some examples, the compression estimation circuit may determine an upper limit of power densities (e.g., Pₖ) for the first range bin, as indicated by block 506. As described above, the upper limit may represent the maximum value of power densities of objects to be detected for the first range bin. The upper limit may be determined by searching for the maximum power level of the range data within the first range bin. Note that in the case of multiple RX antennas, the maximum power level is the maximum (within the first range bin) across the range data corresponding to all the RX antennas.

In some examples, the compression estimation circuit may determine a difference between the lower limit (e.g., P_{weak}) and the upper limit (e.g., Pₖ), as indicated by block 508.

In some examples, the compression circuit may determine a first compression ratio for the first range data of the first range bin based on the difference between the lower limit (e.g., P_{weak}) and the upper limit (e.g., Pₖ), as indicated by block 510. As described above, the compression estimation circuit may determine Δₖ and/or Pₙₒᵢₛₑ for the first range bin based on the lower limit (e.g., P_{weak}) and the upper limit (e.g., Pₖ), e.g., according to equations (7)-(8). The compression estimation circuit may then determine the first compression ratio for the first range bin based on Δₖ and/or Pₙₒᵢₛₑ.

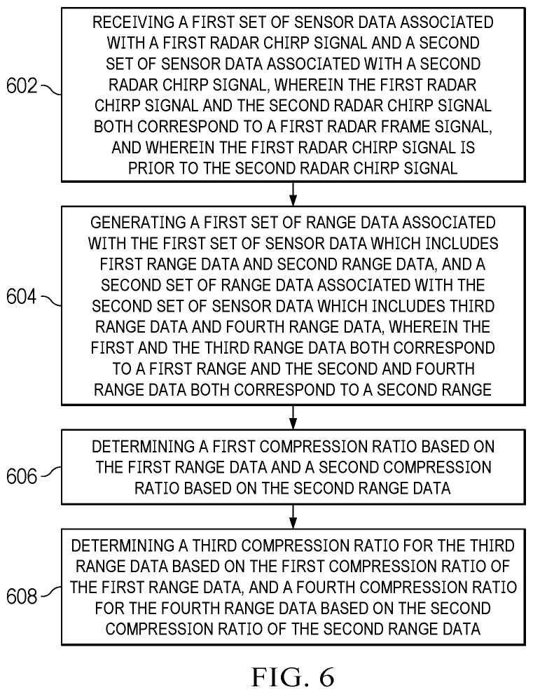

In some examples, a compression estimation circuit may determine the compression ratio for a range bin based on the compression ratio of another range bin. This way, the compression estimation circuit may not necessarily repeat the calculations (e.g., those described in FIG. 5) for the former range bin. This may reduce computation and further improve efficiency of the radar system. FIG. 6 is a flowchart illustrating operations of an intra-frame-based estimation in accordance with some examples. In the intra-frame-based estimation, the compression estimation circuit may determine compression ratios for respective range bins of one radar chirp signal of a radar frame signal. The compression estimation circuit may then adopt the same compression ratios for respective range bins of the subsequent radar chirp signals of the radar frame signal. In some examples, the one radar chirp signal (for which the compression estimation circuit determines the compression rations first) may be the first chirp of the radar frame signal.

In FIG. 6, in some examples, a radar sensor circuit of a radar system (e.g., one similar to the radar sensor circuits described above) may receive a first set of sensor data associated with a first radar chirp signal and a second set of sensor data associated with a second radar chirp signal, wherein the first radar chirp signal and the second radar chirp signal both correspond to a first radar frame signal, and the first radar chirp signal is prior to the second radar chirp signal, as indicated by block 602. For example, referring back to FIG. 2, the first radar chirp signal may correspond to the radar chirp signal 224, and the second radar chirp signal may correspond to the radar chirp signal 228, and the two radar chirp signals may be part of the same radar frame signal. Further, as shown in FIG. 2, the radar chirp signal 224 may be prior to the radar chirp signal 228. Additionally, in some examples, the first radar chirp signal may be the very first chirp of the radar frame signal (to which both the first and second radar chirp signals belong). The first set of sensor data may correspond to the set of digitized data obtained (e.g., by sampling and ADC) from the IF signal associated with the radar chirp signal 224, and the second set of sensor data may correspond to the set of digitized data obtained from the IF signal associated with the radar chirp signal 228.

In some examples, the radar sensor circuit may generate a first set of range data associated with the first set of sensor data and a second set of range data associated with the second set of sensor data, as indicated by block 604. Additionally, the first set of range data may include first range data and second range data, and the second set of range data may include third range data and fourth range data. Further, the first range data and the third range data may both correspond to a first range, and the second range data and the fourth range data may both correspond to a second range. Still, referring to FIG. 2, the first range data may correspond to the range data within the range bin 242, the second range data may correspond to the range data within the range bin 244, such that the first and second range data may both be associated with the radar chirp signal 224. Similarly, the third range data may correspond to the range data within the range bin 252, and the fourth range data may correspond to the range data within the range bin 254, such that the third and fourth range data may both correspond to the radar chirp signal 228. As described in FIG. 2, the range bins associated with the same radar chirp signal may correspond to different ranges, whereas the range bins associated with different radar chirp signals may correspond to the same ranges. Thus, in this example, the first range data of range bin 242 and the third range data of range bin 252 may both correspond to the same (e.g., the first) range, whereas the second range data of range bin 244 and the fourth range data of range bin 254 may both correspond to the same (e.g., the second) range.

In some examples, a compression estimation circuit of the radar system (e.g., one similar to the compression estimation circuits described above) may determine a first compression ratio based on the first range data, and a second compression ratio based on the second range data, as indicated by block 606. For example, the compression estimation circuit may perform operations as described above (e.g., in FIG. 5) for each of the first and second range data to determine their respective compression ratios.

In some examples, the compression estimation circuit may determine a third compression ratio for the third range data based on the first compression ratio of the first range data, and a fourth compression ratio for the fourth range data based on the second compression ratio of the second range data, as indicated by block 608. For example, the compression estimation circuit may determine that the first range data and the third range data both correspond to the same (e.g., the first) range, and that the first range data is prior to the third range data (because the first radar chirp signal is prior to the second radar chirp signal). In response to the determination, the compress estimation circuit may determine the third compression ratio for the third range data to be same as the first compression ratio that has been determined for the first range data. Similarly, the compression estimation circuit may determine that the second range data and the fourth range data both correspond to the same (e.g., the second) range, and that the second range data is prior to the fourth range data (because the first radar chirp signal is prior to the second radar chirp signal). The compression estimation circuit may then determine the fourth compression ratio for the fourth range data to be same as the second compression ratio that has been determined for the second range data. Thus, simply speaking, the intra-frame-based estimation may allow for use of the same compression ratio across range bins (associated with different radar chirp signals within the same radar frame signal) that correspond to the same range, e.g., the compression ratios for the respective range bins of the first chirp of a frame to be used as well for the corresponding range bins of a subsequent chirp of the frame. This strategy while reducing compute time, may also ensure that compressed range data is stored in the memory in an orderly fashion. For example, the compressed range data for a specific range bin across chirps may be accessed by uniform jumps in memory address—making it convenient to access this data using an DMA (Direct Memory Access) Engine. This simplifies data access during subsequent processing of the compressed range data.

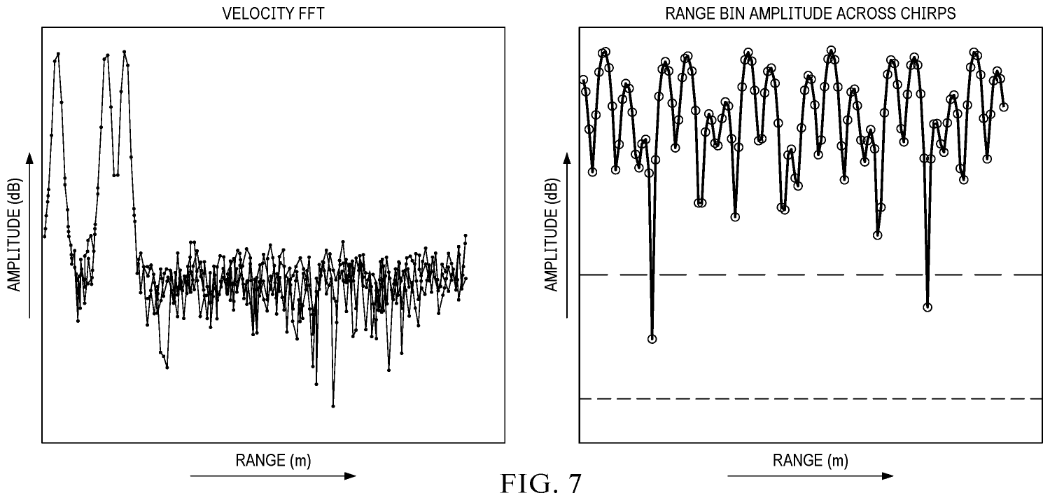

For a single object (i.e., a single tone) in a range, the maximum power level (and thus the upper limits) of the range bins corresponding to a given range may remain substantially constant across different radar chirp signals. In this case, the first radar chirp signal may be used to determine the compression ratios for subsequent chirps, e.g., as described above in the intra-frame-based estimation. However, in the presence of multiple strong objects in the range, the maximum power levels of the range bins may not necessarily remain constant. As shown in FIG. 7, where the velocity FFT for a specific range is on the left (multiple large peaks correspond to multiple strong objects), and the power levels of the range bins across chirps are shown on the right. As shown in FIG. 7, the maximum power levels may vary between the range bins across different chirps.

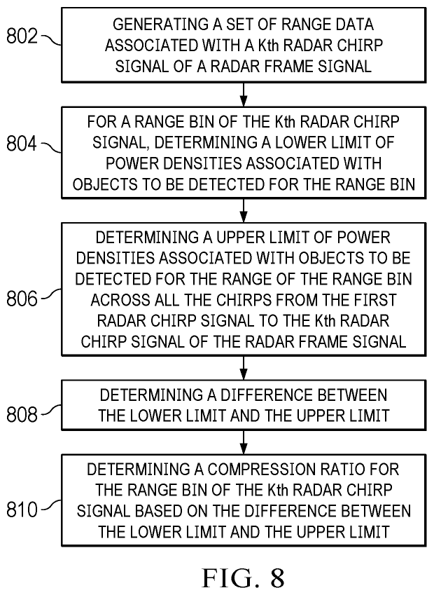

To address such a situation, a compression estimation circuit may use a modified intra-frame-based estimation to determine the compression ratios. FIG. 8 is a flowchart illustrating operations of a modified intra-frame-based estimation in accordance with some examples. In some examples, a radar sensor circuit of a radar system (e.g., one similar to the radar sensor circuits described above) may generate a set of range data associated with a k^{th} radar chirp signal in a frame, as indicated by block 802. For example, as described above, the set of range data may be generated by FFT analysis of the digitized data of the IF signals associated with the k^{th} radar chirp signal.

In some examples, a compression estimation circuit of the radar system (e.g., one similar to the compression estimation circuits described above) may determine a lower limit (e.g., P_{weak}) of power densities associated with objects to be detected for a given range bin of the k^{th} radar chirp signal, as indicated by block 804. For example, the compression estimation circuit may calculate the lower limit according to the operation described above (e.g., in blocks 502-504 of FIG. 5).

In some examples, the compression estimation circuit may determine an upper limit (e.g., P_{k,max}), as indicated by block 806. However, unlike the operations described above (e.g., in block 506 of FIG. 5), the compression estimation circuit may not necessarily determine the upper limit based on only the (maximum power level of) range data within the given range bin. Instead, the upper limit may be based on the range data of all the range bins corresponding to the same range from the 1^{st} radar chirp signal to the k^{th} radar chirp signal of the radar frame signal. For example, the compression estimation may determine an upper limit (e.g., Pₗ) for each of the range bins (corresponding to the same range) across all the chirps from the 1^{st} radar chirp signal to the k^{th} radar chirp signal in the frame, and then determine the maximum of the upper limits such that (P_{k,max}=max_{l=1:k}Pₗ).

In some examples, the compression estimation circuit may determine a difference between the lower limit (e.g., P_{weak}) and the upper limit (e.g., P_{k,max}), as indicated by block 808.

In some examples, the compression estimation circuit may determine a compression ratio for the given range bin of the k^{th} radar chirp signal based on the difference between the lower limit (e.g., P_{weak}) and the upper limit (e.g., P_{k,max}), as indicated by block 810. For example, the compression estimation circuit may determine Δₖ and/or Pₙₒᵢₛₑ for the first range bin based on the lower limit (e.g., P_{weak}) and the upper limit (e.g., P_{k,max}), e.g., according to equations (7)-(8). The compression estimation circuit may then determine the first compression ratio for the first range bin based on Δₖ and/or Pₙₒᵢₛₑ.

In some examples, a compression estimation circuit may determine a compression ratio for range data based on the compression ratio of another range data according to an inter-frame-based estimation. In the inter-frame-based estimation, the compression estimation circuit may determine compression ratios for respective range bins of a radar chirp signal of a radar frame signal. The compression estimation circuit may then use the same compression ratios for range bins of radar chirp signals of a subsequent radar frame signal. In some examples, the radar chirp signal (for which the compression estimation circuit determines the compression ratios first) may be the very last chirp of the earlier radar frame signal.

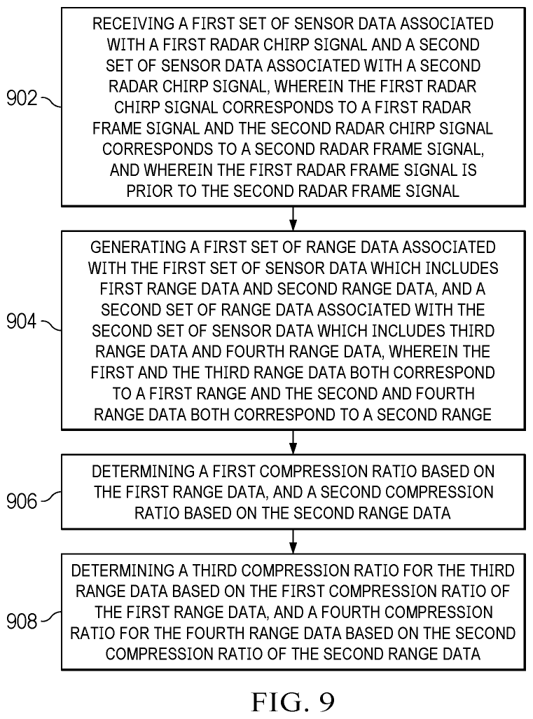

FIG. 9 is a flowchart illustrating operations of an inter-frame-based estimation in accordance with some examples. In some examples, a radar sensor circuit of a radar system (e.g., one similar to the radar sensor circuits described above) may receive a first set of sensor data associated with a first radar chirp signal and a second set of sensor data associated with a second radar chirp signal, wherein the first radar chirp signal may correspond to a first radar frame signal and the second radar chirp signal may correspond to a second radar frame signal, and the first radar frame signal is prior to the second radar frame signal, as indicated by block 902. For example, referring back to FIG. 2, the first radar chirp signal may correspond to the radar chirp signal 224, and the second radar chirp signal may correspond to the radar chirp signal 228. The two radar chirp signals may be part of two different radar frame signals respectively. For example, the radar chirp signal 224 may be part of a first radar frame signal, whereas the radar chirp signal 228 may be part of a second radar frame signal. Further, as shown in FIG. 2, the radar chirp signal 224 (and the first radar frame signal) may be prior to the radar chirp signal 228 (and the second radar frame signal). Additionally, in some examples, the first radar chirp signal may be the very last chirp of the first radar frame signal. The first set of sensor data may correspond to the set of digitized data obtained from the IF signal associated with the radar chirp signal 224, and the second set of sensor data may correspond to the set of digitized data obtained from the IF signal associated with the radar chirp signal 228.

In some examples, the radar sensor circuit may generate a first set of range data associated with the first set of sensor data and a second set of range data associated with the second set of sensor data, as indicated by block 904. Additionally, the first set of range data may include first range data and second range data, and the second set of range data may include third range data and fourth range data. Further, the first range data and the third range data may both correspond to a first range, and the second range data and the fourth range data may both correspond to a second range.

In some examples, a compression estimation circuit of the radar system (e.g., one similar to the compression estimation circuits described above) may determine a first compression ratio based on the first range data, and a second compression ratio based on the second range data, as indicated by block 906. For example, the compression estimation circuit may perform operations as described above (e.g., in FIG. 5) for each of the first and second range data to determine the respective compression ratios.

In some examples, the compression estimation circuit may determine a third compression ratio for the third range data based on the first compression ratio of the first range data, and a fourth compression ratio for the fourth range data based on the second compression ratio of the second range data, as indicated by block 908. For example, the compression estimation circuit may determine that the first range data and the third range data both correspond to the same (e.g., the first) range, the two range data correspond to chirps of different frames, and the first radar frame signal is prior to the second radar frame signal. In response to the determination, the compress estimation circuit may determine the third compression ratio for the third range data to be same as the first compression ratio that has been determined for the first range data. Similarly, the compression estimation circuit may determine that the second range data and the fourth range data both correspond to the same (e.g., the second) range, the two range data correspond to chirps of different frames, and the first radar frame signal is prior to the second radar frame signal. The compression estimation circuit may then determine the fourth compression ratio for the fourth range data to be same as the second compression ratio that has been determined for the second range data. Thus, simply speaking, the inter-frame-based estimation may allow for use of the same compression ratio across range bins (associated with different radar chirp signals of different radar frame signals) that correspond to the same range, e.g., the compression ratios for the respective range bins of the last chirp of a frame to be used as well for the corresponding range bins of the chirps of a subsequent frame. This strategy while reducing compute time, may also ensure that compressed range data is stored in the memory in an orderly fashion. For example, the compressed range data for a specific range bin across chirps may be accessed by uniform jumps in memory address—making it convenient to access this data using an DMA (Direct Memory Access) Engine. This simplifies data access during subsequent processing of the compressed range data.

Sometimes there may be object(s) moving with high velocity(ies) for large frame durations. In this case, the range bin may migrate during the course of a frame. To address the issue, the above described intra-frame-based and/or inter-frame-based estimation may be modified. For example, consider δ to be the maximum number of range bins that an object may migrate, where δ may be calculated according to equation (9):

$$δ = \frac{{v}_{max}}{{R}_{res}} \qquad ( 9 )$$

where vₘₐₓ represents the maximum velocity of the object, and Rᵣₑₛ represents the range resolution. In some examples, the upper limit (e.g., P_{k,max}) for a k^{th} range bin may be determined to be the maximum across all the range bins from the (k-δ)^{th} range bin to the (k+δ)^{th} range bin. Or in other words, (P_{k,max}=max_{l=k-δ:k+δ}Pₗ). Additionally, in some examples, when range-Doppler FFT of a max previous frame is being used, the velocity of the object may be used to calculate δ, such that (δ=vₖ/Rᵣₑₛ) where vₖ represents the velocity of the strongest object in the k^{th} range bin. Once the upper limit P_{k,max} is determined, the compression ratio may be determined for the k^{th} range bin based on P_{k,max} and the lower limit, e.g., as described above.

In some examples, each radar frame signal may be processed by a radar system to generate a point cloud. A point cloud may be a collection of detected targets with an associated range, velocity, and/or angle of arrival for each target. The point cloud generated from a previous frame may be used to determine compression ratios for the range bins of the next frame. Consider an example to identify m targets from a cloud point that belong to a k^{th} range bin. Let Pₖ¹, Pₖ², . . . , Pₖ^{m} be the power densities of these m targets, where the power densities may be calculated based on the targets' RCS according to the radar equation (e.g., equation (6)). In some example, the upper limit P_{k,max} for the k^{th} range bin may be determined as the maximum of Pₖ¹, Pₖ², . . . , Pₖ^{m} (e.g., P_{k,max}=max(Pₖ¹, Pₖ², . . . , pₖ^{m})). Alternatively, in some examples, a more conservative estimation of the upper limit P_{k,max} may be determined according to equation (10). Once the upper limit P_{k,max} is determined, the compression ratio may be determined for the k^{th} range bin based on P_{k,max} and the lower limit, e.g., as described above.

$${P}_{k , max} = 20 {log}_{10} ( 1 {0}^{\frac{{P}_{k}^{1}}{20}} + {10}^{\frac{{P}_{k}^{2}}{20}} + … + {10}^{\frac{{P}_{k}^{m}}{20}} ) \qquad ( 10 )$$

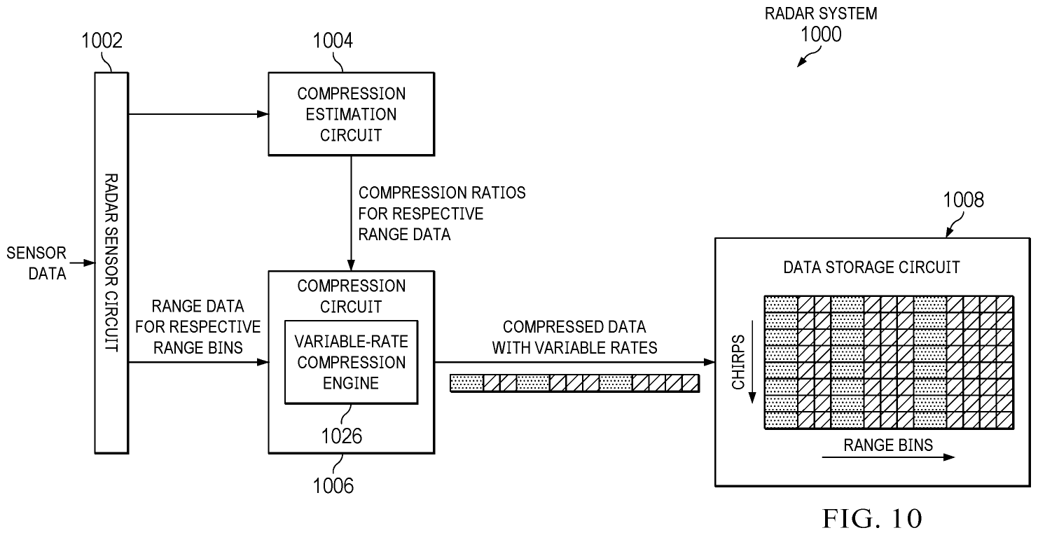

FIG. 10 is a block diagram illustrating implementation of compression circuit and on-chip memory of a radar system in accordance with some examples. In FIG. 10, a radar system 1000 may include a radar sensor circuit 1002, a compression estimation circuit 1004, a compression circuit 1006, and a data storage circuit 1008. In some examples, the radar system 1000 may be similar to the radar systems described above. Additionally, for purposes of illustration, FIG. 10 may not necessarily display all the components of the radar system 1000.

In some examples, the radar sensor circuit 1002 may be similar to the radar sensor circuits described above. The radar sensor circuit 1002 may receive a set of sensor data associated with a radar chirp signal, and generate a set of range data associated with the sensor data (e.g., using a sample circuit and an ADC to generate sample data and an FFT circuit to produce range data based on the sample data).

In some examples, the compression estimation circuit 1004 may be similar to the compression estimation circuit described above. The compression estimation circuit 1004 may receive the set of range data, and determine respective compression ratios for respective ones of the range data of different range bins. Additionally, as described above, in some examples, the compression estimation circuit 1004 may determine the compression ratios for range data of some range bins according to the intra-frame-based estimation, the inter-frame-based estimation, and/or the modified intra-frame-based and/or inter-frame-based estimation.

In some examples, the range data and the respective compression ratios for the range data may be obtained by the compression circuit 1006. In some examples, the compression circuit 1006 may include a single compression engine 1026 that may be able to compress data according to different compression ratios using different compression techniques and/or different compression rates. Thus, as shown in FIG. 10, the compression engine 1026 may compress the range data based on their respective compression ratios to generate corresponding compressed range data with variable rates.

In some examples, the data storage circuit 1008 may be similar to the data storage circuits described above. The compressed range data may be stored at the data storage circuit 1008. As shown in FIG. 10, in some examples, the compressed range data may be organized as a radar data cube. For example, the compressed range data corresponding to a frame may be stored conceptually as a slice of the radar data cube, where the compressed range data corresponding to a chirp may be stored conceptually as a row of the slice, and the compressed range data of different chirps corresponding to the same range may be stored conceptually as a column of the slice.

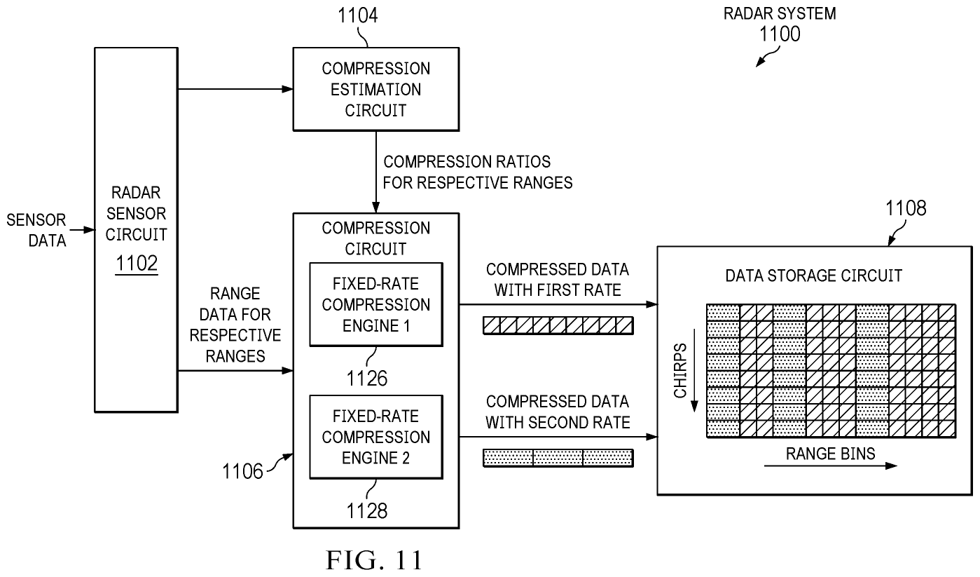

FIG. 11 is a block diagram illustrating another implementation of compression circuit and on-chip memory of a radar system in accordance with some examples. FIG. 11 shows a radar system 1100 similar to the radar system 1000 of FIG. 10. FIG. 11 differs from FIG. 10 in showing separate compression engines to compress range data according to respective compression ratios. Additionally, for purposes of illustration, FIG. 11 may not necessarily display all the components of the radar system 1100.

In some examples, the radar sensor circuit 1102 may be similar to the radar sensor circuits described above. The radar sensor circuit 1102 may receive a set of sensor data associated with a radar chirp signal, and generate a set of range data associated with the sensor data.

In some examples, the compression estimation circuit 1104 may be similar to the compression estimation circuit described above. The compression estimation circuit 1104 may receive the set of range data, and determine respective compression ratios for respective ones of the range data for different range bins. Additionally, as described above, in some examples, the compression estimation circuit 1104 may determine the compression ratios for range data of some range bins according to the intra-frame-based estimation, the inter-frame-based estimation, and/or the modified intra-frame-based and/or inter-frame-based estimation.

In some examples, the range data and the respective compression ratios for the range data may be obtained by the compression circuit 1106. However, unlike the compression circuit 1006 of FIG. 10, in some examples, the compression circuit 1106 may include multiple compression engines 1126 and 1128, each of which may compress data according to a particular compression technique and/or rate to produce a particular compression ratio. For example, the compression circuit 1106 may include a first compression engine 1126 and a second compression engine 11128. The compression engine 1126 may compress first range data based on a first compression ratio to generate a first compressed range data, whereas the compression engine 1128 may compress second range data based on a second compression ratio to generate a second compressed range data.

In some examples, the data storage circuit 1108 may be similar to the data storage circuits described above. The compressed range data may be stored at the data storage circuit 1108. Similarly, in some examples, the compressed range may be stored as a radar data cube.

In some examples, a compression circuit of a radar system (e.g., one similar to the compression circuits described above) may include information indicative of the compression ratio (e.g., by specifying the compression ratio or rate, the compression technique, or a combination thereof) as part of the stored data. For example, consider the stored data as compressed blocks. The compression circuit may include header information indicative of the compression ratio for a compressed block corresponding to the compressed range data of each range bin. For example, the compression circuit may include a first header indicative of a first compression ratio for the compressed block of first range data, and a second header indicative of a second compression ratio for the compressed block of second range data. In some examples, the compression circuit may encoder the headers based on the number of compression ratios. For example, if there are only two compression ratios, the compression circuit may encoder the headers using a 1-bit data, where 0 represents a first compression ratio and 1 represents a second compression ratio. Alternatively, in some examples, instead of include a header for each compressed block, the compression circuit may include a header only in one compressed block per chirp. The header may include information indicative of the compression ratios for all the range bins of the chirp. For example, if the range data corresponding to a radar chirp signal are compressed into two compressed blocks for two range bins respectively, the compression circuit may include a 2-bit header in the first compressed block, where the first bit of the header indicates the compression ratio for the compressed block of the first range bin and the second bit of the header indicates the compression ratio for the compressed block of the second range bin.

In some examples, a compression circuit may compress the range data into super blocks. A super block may include a group of compressed blocks. In some examples, the size of the super blocks may be specified to a constant. For example, the size of the super blocks may be specified to a compressed block corresponding to range data of one range bin that is compressed at a 50% compression ratio. In this case, if the compression circuit compresses range data of a range bin based on the 50% compression ratio, each super block may include only one such compressed block. However, if the compression circuit compresses the range data based on a 25% compression ratio, each super block may include two such compressed blocks. In some examples, a decompression circuit may use transpose access to access compressed data. In this case, the super block (not range bins) may be transposed. When the decompressed circuit accesses a transposed super block, it may access the mantissa size (e.g., in case of a BFP compression) of the compressed super block to determine the number of range bins in the super block. If the mantissa size is 25% compression, there may be two range bins in the super block. Otherwise, if the mantissa size is 50% compression, the super block may include only one range bin. For the 25% case, the first range bin of the super block may be decompressed and then proceed for Doppler processing, then the second range bin may be decompressed and then proceed for Doppler processing. For the 50% case, there may be only one available range bin in the super block for decompression.

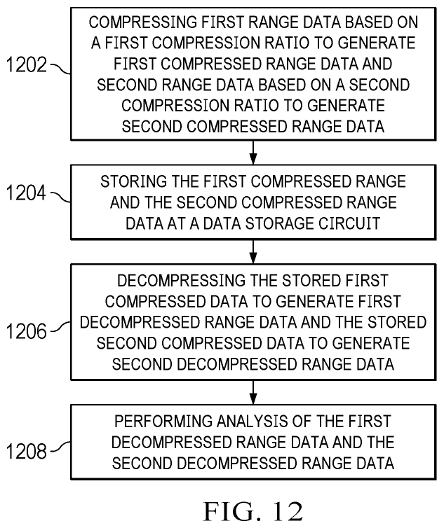

FIG. 12 is a flowchart illustrating some operations of a radar system in accordance with some examples. In some examples, a compression circuit of a radar system (e.g., one similar to the compression circuits described above) may compress first range data based on a first compression ratio to generate first compressed range data, second range data based on second compression ratio to generate a second compressed range data, as indicated by block 1202.

In some examples, a data storage circuit of the radar system (e.g., one similar to the data storage circuits described above) may store the first and second compressed range data, as indicated by block 1204. In some examples, a decompression circuit of the radar system (e.g., one similar to the decompression circuits described above) may decompress the first and second compressed range data to generate first and second decompressed range data, as indicated by block 1206.

In some examples, a processing circuit of the radar system (e.g., one similar to the processing circuits described above) may perform analysis of the first and second decompressed range data, as indicated by block 1208. For examples, the processing circuit may analyze the decompressed range data to determine distance, velocity, acceleration, and/or angle measurements.

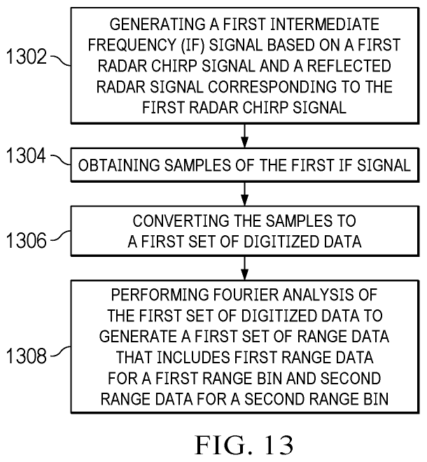

FIG. 13 is a flowchart illustrating some operations of a radar system in accordance with some examples. In some examples, a radar sensor circuit of a radar system (e.g., one similar to the radar sensor circuits described above) may generate a first intermediate frequency (IF) signal based on a first radar chirp signal and a reflected radar signal corresponding to the first radar chirp signal, as indicated by block 1302.

In some examples, the radar sensor circuit may perform sampling of the first IF signal to obtain samples of the IF signal, as indicated by block 1304. In some examples, the radar sensor circuit may perform ADC conversion of the samples to convert the samples to a first set of digitized data, as indicated by block 1306. In some examples, the radar sensor circuit may perform frequency analysis (e.g., FFT) of the first set of digitized data to generate a first set of range data that includes first range data for a first range bin and second range data for a second range bin, as indicated by block 1308.

The term “computer readable medium” as used herein refers to any medium that participates in providing instructions to the processing unit 1104 for execution, and it will be appreciated that a computer readable medium can include multiple computer readable media each operatively connected to the processing unit.

The above examples are non-limiting examples to illustrate several possible embodiments of various aspects of the present disclosure, wherein equivalent alterations and/or modifications will occur to others skilled in the art upon reading and understanding this specification and the annexed drawings. Modifications are possible in the described embodiments, and other embodiments are possible, within the scope of the claims.

The term “couple” is used throughout the specification. The term may cover connections, communications, or signal paths that enable a functional relationship consistent with this description. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B. As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

What is claimed is:

1. A system, comprising:
a radar sensor circuit configured to:
receive a first set of sensor data associated with a first radar chirp signal; and
generate a first set of range data associated with the first set of sensor data which includes first range data for a first range bin and second range data for a second range bin; and
a compression estimation circuit coupled to the radar sensor circuit and configured to:
determine a first compression ratio for the first range data based on the first range data; and
determine a second compression ratio for the second range data based on the second range data.

2. The system of claim 1, wherein:
the radar sensor circuit is configured to:
receive a second set of sensor data associated with a second radar chirp signal; and
generate a second set of range data associated with the second set of sensor data which includes third range data for a third range bin and fourth range data for a fourth range bin; and
the compression estimation circuit is configured to:
determine a third compression ratio for the third range data based on the first compression ratio of the first range data; and
determine a fourth compression ratio for the fourth range data based on the second compression ratio of the second range data.

3. The system of claim 2, wherein to determine the third and fourth compression ratios, the compression estimation circuit is configured to:
determine that the first and third range bins both correspond to a first range; and
determine that the second and fourth range bins both correspond to a second range.

4. The system of claim 2, wherein to determine the third and fourth compression ratios, the compression estimation circuit is configured to:
determine that the first radar chirp signal and the second radar chirp signal both correspond to a first radar frame signal; and
determine that the first radar chirp signal is prior to the second radar chirp signal.

5. The system of claim 2, wherein to determine the compression ratios for the third and fourth range data, the compression estimation circuit is configured to:
determine that the first radar chirp signal corresponds to a first radar frame signal;
determine that the second radar chirp signal corresponds to a second radar frame signal; and
determine that the first radar frame signal is prior to the second radar frame signal.

6. The system of claim 5, wherein to determine the compression ratios for the third range data and the fourth range data, the compression estimation circuit is configured to:
determine that the first radar chirp signal is a last one of a plurality of radar chirp signals of the first radar frame signal.

7. The system of claim 1, wherein to determine the first compression ratio, the compression estimation circuit is configured to:
determine a lower limit of power densities associated with objects to be detected for the first range bin;
determine an upper limit of power densities associated with the objects to be detected for the first range bin; and
determine the first compression ratio based on the lower limit and the upper limit.

8. The system of claim 7, wherein to determine the first compression ratio, the compression estimation circuit is configured to:
determine a difference between the lower limit and the upper limit; and
determine the first compression ratio based on the difference.

9. The system of claim 7, wherein to determine the upper limit, the compression estimation circuit is configured to:
determine a maximum value of power densities associated with the objects to be detected for the first range bin.

10. The system of claim 7, wherein to determine the lower limit, the compression estimation circuit is configured to:
obtain a radar cross section (RCS) associated with a specified one of the objects to be detected for the first range bin; and
determine the lower limit based on the RCS.

11. The system of claim 1, wherein to determine the first compression ratio, the compression estimation circuit is configured to:
determine a lower limit of power densities associated with objects to be detected for the first range bin;
determine an upper limit of power densities associated with objects to be detected for the first range bin and a third range bin, wherein the third range bin corresponds to a third radar chirp signal, wherein the first and third radar chirp signals both correspond to a first radar frame signal and the third radar chirp signal is prior to the first radar chirp signal, and wherein the first and third range bins both correspond to a first range;
determine the first compression ratio based on the lower limit and the upper limit.

12. The system of claim 1, further comprising:
a signal mixer coupled to the radar sensor circuit and configured to:
generate a first intermediate frequency (IF) signal based on the first radar chirp signal and a reflected radar signal corresponding to the first radar chirp signal,
wherein to generate the first range data and the second range data, the radar sensor circuit is configured to:
obtain samples of the first IF signal;
perform analog-to-digital conversion of the samples to generate the first set of sensor data; and
perform Fourier analysis of the first set of sensor data to generate the first range data and the second range data.

13. The system of claim 1, further comprising:
a compression circuit coupled to the compression estimation circuit and radar sensor circuit and configured to:
compress the first range data using a compression algorithm based on the first compression ratio to generate first compressed range data; and
compress the second range data using a second compression algorithm based on the second compression ratio to generate second compressed range data,
wherein the first and second compression algorithms comprise at least one of a block floating point (BFP) compression or an Exponential Golomb Encoding (EGE).

14. The system of claim 13, wherein the compression circuit comprises a compression engine configured to compress both the first range data and the second range data based on the first compression ratio and the second compression ratio respectively.

15. The system of claim 13, wherein the compression circuit comprises:
a first compression engine configured to compress the first range data based on the first compression ratio; and
a second compression engine configured to compress the second range data based on the second compression ratio.

16. The system of claim 13, further comprising:
a storage circuit configured to store the first compressed range data and the second compressed range data.

17. A method, comprising:
receiving a first set of sensor data associated with a first radar chirp signal;
generating a first set of range data associated with the first set of sensor data, wherein the first set of range data comprises first range data for a first range bin and second range data for a second range bin;
determining a first compression ratio for the first range data based on the first range data and a second compression ratio for the second range data based on the second range data; and
compressing the first range data based on the first compression ratio and the second range data based on the second compression ratio.

18. The method of claim 17, further comprising:
receiving a second set of sensor data associated with a second radar chirp signal;
generating a second set of range data associated with the second set of sensor data, wherein the second set of range data comprises third range data for a third range bin and fourth range data for a fourth range bin; and
determining a third compression ratio for the third range data based on the first compression ratio of the first range data and a fourth compression ratio for the fourth range data based on the second compression ratio of the second range data.

19. The method of claim 18, wherein determining the third and fourth compression ratios comprises:
determining that the first and third range bins both correspond to a first range and the second and fourth range bins both correspond to a second range; and
determining that the first radar chirp signal and the second radar chirp signal both correspond to a first radar frame signal and the first radar chirp signal is prior to the second radar chirp signal.

20. The method of claim 18, wherein determining the third and fourth compression ratios comprises:
determining that the first and third range bins both correspond to a first range and the second and fourth range bins both correspond to a second range; and
determining that the first radar chirp signal corresponds to a first radar frame signal, the second radar chirp signal corresponds to a second radar frame signal, and the first radar frame signal is prior to the second radar frame signal.
